(19) United States
(12) Patent Application Publication
(10) Pub. No.: US 2023/0030169 A1
(43) Pub. Date: Feb. 2, 2023

(54) ADMINISTRATOR'S PASSWORD RESETTING

(71) Applicant: HEWLETT-PACKARD DEVELOPMENT COMPANY, L.P., Spring, TX (US)

(72) Inventors: In Cheon Park, Pangyo (KR); Kwangwoo Lee, Seongnam Si (KR); Sun Young Park, Seongnam Si (KR)

(21) Appl. No.: 17/758,513

(22) PCT Filed: Nov. 20, 2020
(86) PCT No.: PCT/US2020/061452

§ 371 Date: Jul. 8, 2022

(30) Foreign Application Priority Data
Mar. 31, 2020 (KR) 10-2020-0039351

(51) Int. Cl. G06F 21/45; G06F 21/34

(52) U.S. Cl. CPC G06F 21/45; G06F 21/34; G06F 2221/2131

(57) ABSTRACT

An example image forming device includes an input device to receive authentication information input from predefined users, a memory, and a processor to execute an administrator password resetting mode in a case where the authentication information is input from t (where t=a natural number) or more of the predefined users through the input device, change an existing administrator password to a reset administrator password, and store the reset administrator password in the memory.

### BACKGROUND

An image forming device may refer to a device that outputs printing data generated by a terminal device such as a computer on a printing medium such as paper. An example of such an image forming device may include a copier, a printer, a scanner, a facsimile, a multi-function peripheral (MFP) in which functions of the copier, the printer, the scanner, and the facsimile are complexly implemented through one device, and the like.

### BRIEF DESCRIPTION OF THE DRAWINGS

FIG. 1 is a block diagram illustrating an image forming device according to an example;

FIG. 2 is a block diagram illustrating a more detailed example of an image forming device;

FIG. 3 is a block diagram illustrating a processor according to an example;

FIG. 4 is a flowchart for describing a control method of an image forming device according to an example;

FIG. 5A is a view illustrating an example of a user interface window for inputting authentication information that may be displayed on a display;

FIG. 5B is a view illustrating another example of a user interface window for inputting authentication information that may be displayed on a display;

FIG. 5C is a view illustrating an example of a user interface window for resetting an administrator password that may be displayed on a display;

FIG. 6 is a flowchart for describing a method of resetting an administrator password according to an example;

FIG. 7 is a flowchart for describing a method of resetting an administrator password according to another example;

FIG. 8 is a diagram for describing identification of a secret key of an image forming device according to an example;

FIG. 9A is a view for describing information of a license stored in a portable memory according to an example;

FIG. 9B is a view for describing information of a license stored in a portable memory according to another example; and

FIG. 10 is a flowchart for describing a method of resetting an administrator password according to another example.

### DETAILED DESCRIPTION

Various examples are described below with reference to the drawings. The examples described may be modified into several different forms.

In the following description, when a component is referred to as being “connected to” another component, it means that the component and the other component are “directly connected to” each other or are “connected to” each other with yet another component interposed therebetween. In addition, when a component is referred to as “including” another component, it means that yet another component may also be included, rather than the exclusion of other components, unless explicitly described to the contrary.

In the following description, an “image forming job” may refer to any of various jobs (for example, copying, printing, scanning, or faxing) related to an image, such as forming of the image or generating/storing/transmitting of an image file, and a “job” may refer to not only the image forming job, but also include any of a series of processes required for performing the image forming job.

In addition, an “image forming device” may refer to a device that outputs (e.g., prints, copies, etc.) printing data generated in a terminal device such as a computer on a recording medium such as paper. An example of such an image forming device may include a copier, a printer, a scanner, a facsimile, a multi-function peripheral (MFP) in which functions of the copier, the printer, the scanner, and the facsimile are complexly implemented through one device, or the like.

Further, “printing data” may refer to data converted into a format printable in a printer. In an example, when the printer supports direct printing, a file itself may be the printing data.

Further, a “user” may refer to a person performing a manipulation on the image forming job using the image forming device or using a device connected to the image forming device in a wired or wireless manner. Further, an “administrator” may refer to a person having an authority to access all functions and systems of the image forming device. The “administrator” and the “user” may be the same person.

Further, an “initial password” may be a password for accessing the image forming device or an account (e.g., a user account, an administrator account, etc.), and may be a unique value having different values for each image forming device released from a manufacturer. Such an initial password may be generated using a product serial number, a model name, a media access control (MAC) address, a random number of the image forming device, or the like.

Further, an “administrator password” may be a password set by changing the “initial password” by the administrator.

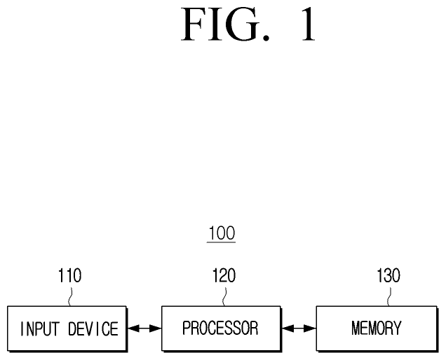

FIG. 1 is a block diagram illustrating an image forming device according to an example.

Referring to FIG. 1, an image forming device 100 may include an input device 110, a processor 120, and a memory 130.

The image forming device 100 may provide various security functions such as network security, user authentication, system setting change, audit record, storage medium encryption, complete deletion, access control, or the like. Such a security setting may be administered by a reliable user or administrator set in advance in order to ensure safety.

An initial password of an account necessary to perform such administration may be provided to a user or an administrator having direct access to the image forming device. In an example, the administrator may change the initial password to an administrator password, and an administrator mode of the image forming device may be accessed only by the administrator. A case may occur in which the administrator may not access the administrator mode, such as a case where the administrator forgets the administrator password. In that case, it is desirable to have a method by which an initial administrator password may be changed.

In an example, at the time of setting the administrator password, the administrator may give authentication information to N predefined users. For example, the authentication information may include user identification information, a password, information stored in an authentication card, information stored in a portable memory, or the like. The N predefined users may be given different authentication information, respectively. In addition, the administrator may set the number of minimum authentication information for changing the administrator password of the image forming device to t (N≥t). In a case in which it is desired to change the administrator password, the image forming device 100 may execute an administrator password resetting mode when authentication information of set t users of the N predefined users is input. Here, N and t may be natural numbers.

The input device 110 may receive authentication information input from a predefined user. As described above, the input device 110 may receive authentication information input from t or more users of the N predefined users. The input device 110 may sequentially receive authentication information input from predefined t users at the time of receiving the authentication information. The image forming device 100 may execute the administrator password resetting mode when t or more of preset N authentication information is input. When the administrator password resetting mode is executed, the input device 110 may receive a new administrator password that is input. For example, the input device 110 may include a touch screen control panel, a keyboard, a card reader, a portable memory interface port, or the like.

The memory 130 may store an instruction regarding the image forming device 100. For example, various programs (or software) for operating the image forming device 100 according to various examples may be stored in the memory 130. In addition, the memory 130 may store an initial administrator password, information capable of identifying authentication information input in order to execute the administrator password resetting mode, the number of authentication information, or the like.

The processor 120 may control an operation of the image forming device 100. For example, the processor 120 may control an operation of the image forming device 100 by executing an instruction stored in the memory 130.

In a case where the authentication information is input from t or more of the N predefined users through the input device 110, the processor 120 may execute the administrator password resetting mode. In addition, in a case where a new administrator password is input through the input device 110, the processor 120 may change the existing administrator password to the new administrator password and store the changed administrator password in the memory 130.

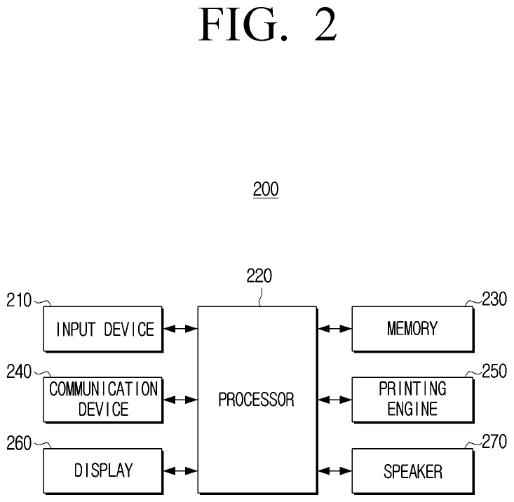

In the example of FIG. 1, various components of the image forming device 100 have been illustrated and described hereinabove. However, other components may be further included in the image forming device 100 at the time of implementing the image forming device 100. Examples of these components will be described below with reference to FIG. 2.

FIG. 2 is a block diagram illustrating a more detailed example of an image forming device.

Referring to FIG. 2, an image forming device 200 may include an input device 210, a processor 220, a memory 230, a communication device 240, a printing engine 250, a display 260, and a speaker 270.

The memory 230 may perform the same function as that of the memory 130 of FIG. 1, and an overlapping description will thus be omitted. In addition, since the input device 210 and the processor 220 may perform functions similar to those of the input device 110 and the processor 120 of FIG. 1, the contents described in FIG. 1 will not be repeatedly described, and only contents related to components added in FIG. 2 will be described below.

The input device 210 may receive a function selection and a control command for the function, input from a user. Here, the function may include a printing function, a copying function, a scanning function, a fax transmitting function, or the like.

The communication device 240 may connect the image forming device 200 to an external device (not illustrated). As an example, the communication device 240 may connect the image forming device 200 to the external device through a local area network (LAN), an Internet network, a universal serial bus (USB) port, or a wireless communication (for example, wireless fidelity (WiFi), 802.11a/b/g/n, near field communication (NFC), Bluetooth, etc.) port. Such a communication device 240 may also be referred to as a transceiver.

The communication device 240 may receive a control command input through the external device and receive printing data. In addition, the communication device 240 may transmit and receive information for administrator password resetting. As an example, the image forming device 200 may request the user to perform the administrator password resetting. The image forming device 200 may request predefined N users to approve the administrator password resetting. When t or more of the predefined N users approve the administrator password resetting, the image forming device 200 may execute the administrator password resetting mode. In an example, the image forming device 200 may request a cloud based device such as a server (hereinafter “cloud”) to approve the administrator password resetting through the user, and the cloud may transmit approval data of n or more of the predefined N users to the image forming device 200. For example, the approval of the predefined user may be performed in a manner such as email approval or approval after the predefined user accesses the cloud. In an example, the approval information of the predefined user may be authentication information. When the image forming device 200 performs the administrator password resetting mode, the user may reset the administrator password.

The printing engine 250 may form an image. For example, the printing engine 250 may print a printing image generated by the processor 220 on a printing medium such as paper. The printing engine 250 may perform printing in an electrophotographic manner, an inkjet manner, or the like. The printing engine 250 may be a mono printing engine capable of printing only one color or may be a color printing engine capable of color printing. In addition, when the printing data is received through the communication device 240, the processor 220 may control the printing engine 250 to print the received printing data.

The display 260 may display a user interface window for receiving a selection of a function supported by the image forming device 200. For example, the display 260 may display a user interface window for receiving a selection of various functions provided by the image forming device 200. Such a display 260 may be a monitor such as a liquid crystal display (LCD), a cathode ray tube (CRT), a light emitting diode (LED), or an organic LED (OLED), and may be implemented by a touch screen capable of simultaneously performing a function of the input device 210.

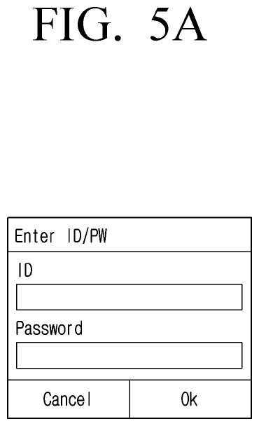

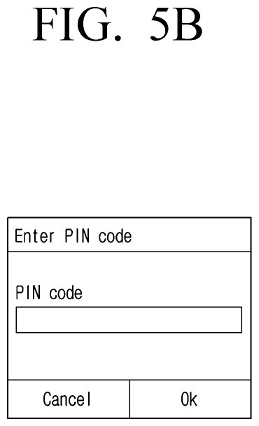

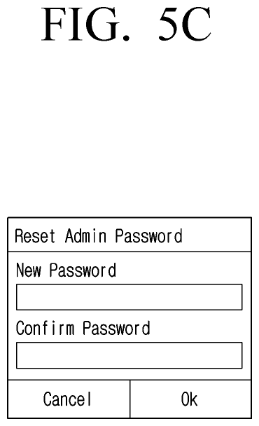

The display 260 may display a user interface window for receiving authentication information input from the user or a user interface window for receiving a new administrator password input from the user. In addition, the display 260 may display a user interface window for displaying an error message generated in an administrator password resetting process. An example of a user interface window that may be displayed on the display 260 will be described later with reference to FIGS. 5A to 5C.

The speaker 270 may output state information of the image forming device 200 as a sound. For example, when the image forming device 200 is in an error state, the speaker 270 may output a sound corresponding to the error state. In an example, the speaker 270 may output a sound corresponding to an error generated in the administrator password resetting process.

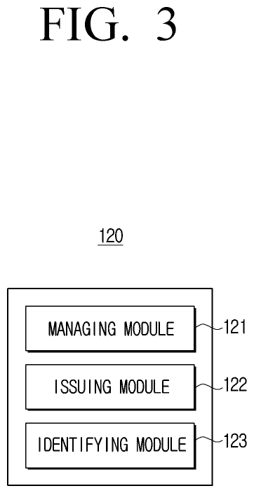

FIG. 3 is a block diagram illustrating a processor according to an example.

Referring to FIG. 3, the processor 120 may include a managing module 121, an issuing module 122, and an identifying module 123.

The managing module 121 may be a module to register and manage information in a personal computer (PC) or a mobile device using software managing the image forming device in an embedded web server (EWS) embedded in the image forming device 100 or in a cloud outside the image forming device 100. The managing module 121 may provide an option setting for resetting the password through an external management means. In addition, at the time of making a request for administrator password resetting, the managing module 121 may receive approval from predefined users and perform the administrator password resetting process.

When there is a request for a specific license for the administrator password resetting of the image forming device 100 from the managing module 121, the issuing module 122 may issue the specific license for the image forming device 100 and a PIN code matched to the specific license and transfer the specific license and the PIN code to the managing module 121.

The identifying module 123 may determine user input information for the image forming device 100. The identifying module 123 may determine whether the user is the predefined user by comparing the authentication information input by the predefined user with stored user information. In an example, the identifying module 123 may confirm whether specific license information is present in the image forming device 100 and verify the license when the specific license information is present. In addition, in a case where a PIN code verification option is set, the identifying module 123 may perform a process of identifying the PIN code.

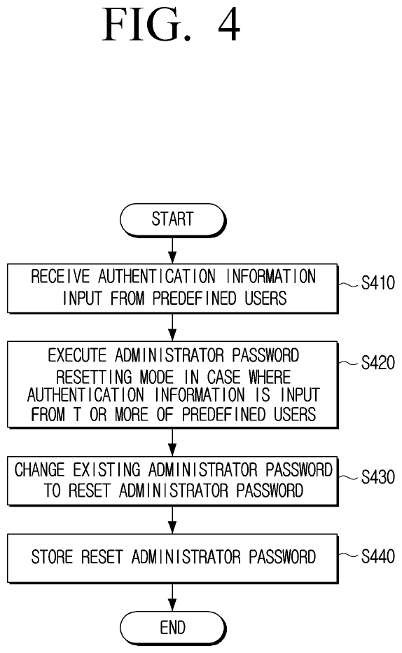

FIG. 4 is a flowchart for describing a control method of an image forming device according to an example.

Referring to FIG. 4, the image forming device may receive authentication information input from predefined users in operation S410. For example, the authentication information may include identification information of the predefined user, a password, information stored in an authentication card, information stored in a portable memory, or the like. The image forming device may sequentially receive the authentication information from the predefined users. In an example, the image forming device may receive the authentication information from the predefined users according to a request signal for administrator password resetting through the cloud.

The image forming device may execute an administrator password resetting mode in the case where the authentication information is input from t or more of the predefined users in operation S420. For example, the number of predefined users may be N. In addition, the image forming device may execute the administrator password resetting mode when the authentication information is input from t or more of the N predefined users (N≥t).

The image forming device may change an existing administrator password to a reset administrator password in operation S430. The image forming device may display a user interface window for administrator password resetting. The image forming device may store the reset administrator password in operation S440. Through the example processes described above, the image forming device may change the administrator password without affecting other stored data.

FIG. 5A is a view illustrating an example of a user interface window for inputting authentication information that may be displayed on a display, FIG. 5B is a view illustrating another example of a user interface window for inputting authentication information that may be displayed on a display, and FIG. 5C is a view illustrating an example of a user interface window for resetting an administrator password that may be displayed on a display.

Referring to FIG. 5A, a user interface window in which an ID and a password may be input is illustrated, and referring to FIG. 5B, a user interface window in which a PIN code may be input is illustrated. The image forming device may receive authentication information input through the input device in the image forming device. As an example, the input device may include a touch screen panel, a keyboard, or the like. The image forming device may receive authentication information input from predefined users in order to change the administrator password.

The authentication information may be an ID and a password of the predefined user, as illustrated in FIG. 5A or may be a PIN code as illustrated in FIG. 5B. In an example, the image forming device may display a user interface window for inputting the authentication information sequentially until t users for changing the administrator password input the authentication information. That is, when a predefined first user inputs an ID/PW or a PIN code, the image forming device may display a user interface window for inputting the authentication information again. When a predefined second user inputs an ID/PW or a PIN code, the image forming device may display a user interface window for inputting the authentication information again. When a predefined t-th user inputs an ID/PW or a PIN code, the image forming device may display a user interface window in which a new administrator password may be input as illustrated in FIG. 5C.

The user may input the new administrator password through the input device. The display may display a user interface window corresponding to the input administrator password. In addition, when the input of the new administrator password ends, the image forming device may change the existing administrator password to the new administrator password and store the new administrator password.

Hereinafter, various examples of resetting an administrator password will be described.

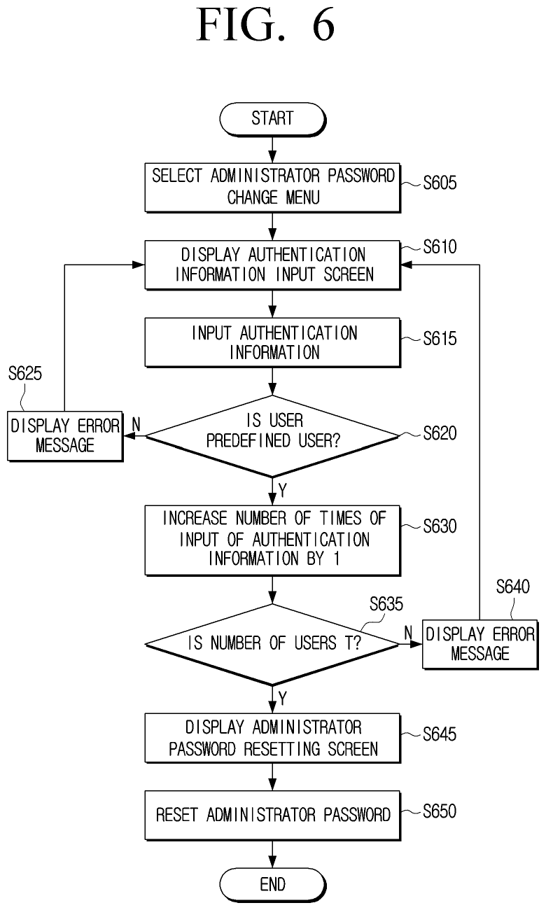

FIG. 6 is a flowchart for describing a method of resetting an administrator password according to an example.

In FIG. 6, an example in which a predefined user resets an administrator password by directly inputting authentication information through an input device is illustrated.

Referring to FIG. 6, the user may select an administrator password change menu in the image forming device in operation S605. When the administrator password change menu is selected, the image forming device may display an authentication information input screen in operation S610. An example of a screen displayed by the image forming device has been described with reference to FIGS. 5A and 5B.

The predefined user may input authentication information in operation S615. For example, the authentication information may be an ID, a password, a PIN code, or the like. The image forming device may determine whether the user is the predefined user on the basis of the input authentication information in operation S620. The image forming device may store user information, PIN information, or the like, for N users at the time of setting the previous administrator password. The image forming device may determine whether the user is the predefined user by comparing the input authentication information with the stored user information or the like.

In a case where the user who has input the authentication information is not the predefined user, the image forming device may display an error message in operation S625. In an example, the image forming device may output the error message as a sound.

When the user who has input the authentication information is the predefined user, the image forming device may increase the number of times of the input of the authentication information by 1 in operation S630. The image forming device may determine whether the number of users who have input the authentication information is t in operation S635. In a case where the number of users who have input the authentication information is not t, the image forming device may display an error message in operation S640. In addition, the image forming device may output the error message as a sound. In an example, the image forming device may output a screen for receiving authentication information input from the next user without outputting the error message. The image forming device may sequentially receive the authentication information input from predefined first to t-th users.

In a case where the number of users who have input the authentication information is t, the image forming device may display an administrator password resetting screen in operation S645. An example of an administrator password resetting screen displayed by the image forming device has been described with reference to FIG. 5C. When the user inputs a new administrator password, the image forming device may reset the administrator password in operation S650. The image forming device may delete the existing administrator password and store the reset administrator password in the memory.

An example in which the user directly inputs the authentication information through the input device of the image forming device has been described. However, a manner of inputting a card in which the authentication information is stored to the image forming device through a card reader may be performed by the same process as the process described above. That is, the predefined t users may execute the administrator password resetting mode by sequentially tagging cards including the authentication information in the card reader of the image forming device.

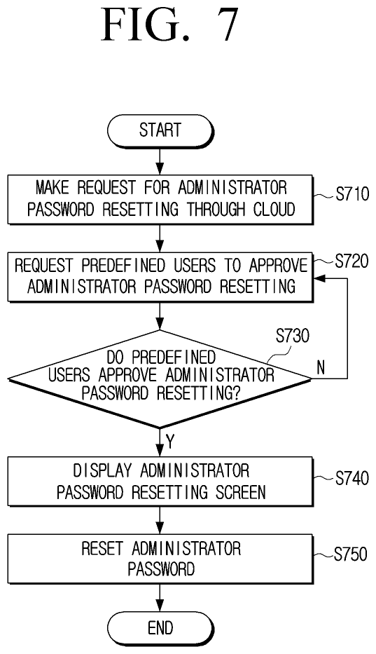

FIG. 7 is a flowchart for describing a method of resetting an administrator password according to another example.

In FIG. 7, an example in which a predefined user resets an administrator password by transmitting authentication information through a cloud is illustrated.

Referring to FIG. 7, the user may make a request for administrator password resetting through the cloud in operation S710. The cloud may transmit an approval request signal to N predefined users in operation S720. The predefined users may approve the administrator password resetting. For example, each of the predefined users may approve the administrator password resetting in a manner such as email approval or approval after the predefined user accesses the cloud. The approval of the predefined user may be the same process as the input of the authentication information. The approval information of the predefined user may be transmitted to the cloud.

The cloud may determine whether t users have approved the administrator password resetting in operation S730. In a case where the t users have not approved the administrator password resetting, the cloud may again transmit the approval request signal to predefined users that have not approved the administrator password resetting among the N predefined users. In a case where the t or more users have approved the administrator password resetting, the cloud may transmit approval information (or authentication information) to the image forming device.

The image forming device receiving the approval information from the cloud may display an administrator password resetting screen in operation S740. When the user inputs a new administrator password, the image forming device may reset the administrator password in operation S750. The image forming device may delete the existing administrator password and store the reset administrator password in the memory.

In an example, when the system is in use, the image forming device may execute the administrator password resetting mode at the time of being rebooted.

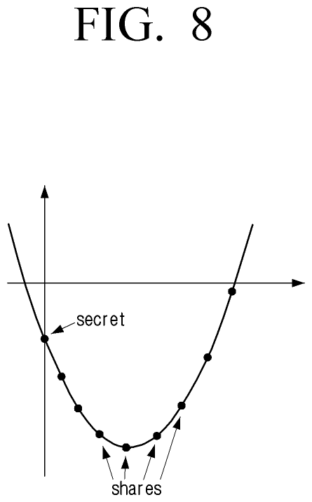

FIG. 8 is a diagram for describing identification of a secret key of an image forming device according to an example.

In an example, the administrator password resetting mode may be executed by N portable memories in which divided licenses are stored. The administrator password resetting mode executed by the N portable memories in which the divided licenses are stored may use a secret sharing algorithm.

The secret sharing algorithm may use the mathematical fact that “a t-1-th order polynomial of x passing through t points whose x-axis coordinate values are different from each other is uniquely determined”. For example, two points may determine one straight line, and three points may uniquely determine one parabola.

In FIG. 8, a quadratic curve in a case where N=7 and t=3 is illustrated. In general, in a case where only one of the t points is insufficient, there are numerous t-1-th order polynomials as candidates, and thus, an original polynomial may not be guessed. Therefore, a secret value of the image forming device is not exposed until t or more points are known.

When it is assumed that S is a secret value of the image forming device in FIG. 8, the numbers t and N of information necessary to recover the secret value may be set (N≥t). In addition, a polynomial q(x) may be arbitrarily determined as in Equation (1) (a0=q(x)=S).

q(x)=a₀+a₁x+a₂x²+ . . . +a_{T-1}x^{T-1} Equation (1)

In Equation (1), n points ((1, q(1)), (2, q(2)), . . . , (n, q(n)) on a polynomial function y=q(y) may be secret values stored in N portable memories.

An example process of recovering the secret value of the image forming device may be performed as follows.

T points (shared secrets) on a polynomial function y=q(x) are collected, and q(x) may be found through polynomial interpolation. q(0) is an original secret value S. The polynomial interpolation is a manner of finding a polynomial passing through all given points, and may be represented by Equations (2) and (3).

$$q ( x ) = \frac{( x - {x}_{1} ) ( x - {x}_{2} ) … ( x - {x}_{m} )}{( {x}_{0} - {x}_{1} ) ( {x}_{0} - {x}_{2} ) … ( {x}_{0} - {x}_{m} )} {y}_{0} + \frac{( x - {x}_{0} ) ( x - {x}_{2} ) … ( x - {x}_{m} )}{( {x}_{1} - {x}_{0} ) ( {x}_{1} - {x}_{2} ) … ( {x}_{1} - {x}_{m} )} {y}_{1} + … + \frac{( x - {x}_{0} ) ( x - {x}_{1} ) … ( x - {x}_{m - 1} )}{( {x}_{m} - {x}_{0} ) ( {x}_{m} - {x}_{1} ) … ( {x}_{m} - {x}_{m - 1} )} {y}_{m} \qquad Equation ( 2 )$$

$$q ( x ) = {\sum }_{i = 0}^{n} ( \prod 0 \leq j \leq n , j \neq i \frac{x - {x}_{j}}{{x}_{i} - {x}_{j}} ) {y}_{i} \qquad Equation ( 3 )$$

The license including the secret value shared in the manner described above may be stored in the N portable memories. In addition, in a case of receiving secret values input from predefined t users, the image forming device may determine whether the input secret values coincide with the previous secret values of the image forming device on the basis of the number of input secret values and the polynomial interpolation, and execute the administrator password resetting mode.

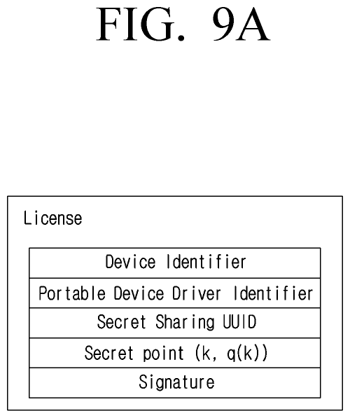

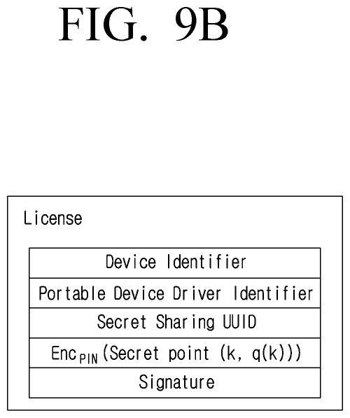

FIG. 9A is a view for describing information of a license stored in a portable memory according to an example, and FIG. 9B is a view for describing information of a license stored in a portable memory according to another example. An example will be described with reference to FIGS. 9A and 9B.

Referring to FIG. 9A, a license stored in one portable memory may include a device identifier, a portable memory driver identifier, a secret sharing universally unique identifier (UUID), a secret point, and a signature.

The device identifier may include an identification number capable of uniquely identifying the image forming device. In an example, a license issued by the image forming device is valid only for the image forming device. For example, the identification number may include a device serial number or the like. The portable memory driver identifier is an identification number capable of uniquely identifying the portable memory, and may be used to prevent duplication of the license. However, the portable memory driver identifier may also be omitted.

The secret sharing UUID may include a unique number for a secret sharing problem, and may be a number that increases each time it is issued from the image forming device. The secret sharing UUID may be used to determine whether a license is a license that is no longer valid.

The secret point may include a value used in secret sharing, and different secret points may be stored in the respective portable memories. The signature may concatenate the device identifier, the portable memory driver identifier, the secret sharing UUID, and the secret point to each other. A hash value may be calculated by a designated algorithm based on the secret point. The signature may be signed with a private key stored in the image forming device or the cloud.

Referring to FIG. 9B, the license may be encrypted with a PIN in order to prevent unauthorized use of the license. When the portable memory in which the license is stored is inserted into the image forming device, the image forming device may request the user to input the PIN. In this case, a license stored in one portable memory may include a device identifier, a portable memory driver identifier, a secret sharing UUID, an encrypted secret point (EncPIN(Secret point)), and a signature.

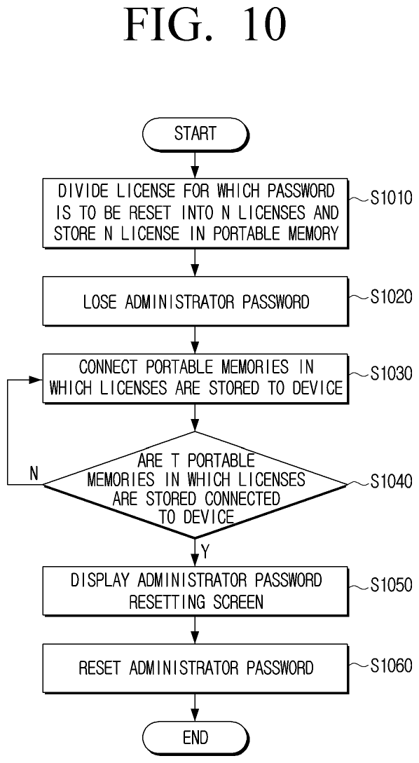

FIG. 10 is a flowchart for describing a method of resetting an administrator password according to another example.

In FIG. 10, an example of resetting an administrator password using a portable memory storing a shared license is illustrated.

Referring to FIG. 10. the user may divide a license for which a password is to be reset into N licenses using an image forming device and store the N licenses in the portable memory in operation S1010. Examples of information included in the licenses stored in the respective portable memories and a secret sharing manner have been described above.

In a case where the administrator loses the administrator password in operation S1020, the predefined users may connect the portable memories in which the licenses are stored to the image forming device in operation S1030. The predefined users may sequentially connect the portable memories in which the licenses (i.e., authentication information) are stored to the image forming device. In an example, in a case where the license stored in the portable memory includes an encrypted secret point, the image forming device may request the predefined user to input a PIN.

The image forming device may determine whether t portable memories in which the licenses are stored are connected to the image forming device in operation S1040. In a case where fewer than t portable memories are connected to the image forming device, the image forming device may wait until the t portable memories are connected the image forming device.

In a case where the t portable memories in which the licenses are stored are connected to the image forming device, the image forming device may display an administrator password resetting screen in operation S1050. When the user inputs a new administrator password, the image forming device may reset the administrator password in operation S1060. The image forming device may delete the existing administrator password and store the reset administrator password in the memory.

The example methods of resetting an administrator password described above may be implemented as a program and provided to the image forming device. For example, a program including the method of resetting an administrator password may be stored and provided in a non-transitory computer readable medium.

The non-transitory computer readable medium is not a medium that stores data for a while, such as a register, a cache, a memory, or the like, but refers to a medium that semi-permanently stores data and is readable by an apparatus. For example, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

Although examples have been illustrated and described hereinabove, the present disclosure is not limited to the examples described above, but may be variously modified by those skilled in the art to which the present disclosure pertains without departing from the gist of the present disclosure as disclosed in the accompanying claims. These modifications should also be understood to fall within the scope and spirit of the present disclosure.

What is claimed is:

1. An image forming device comprising:
an input device to receive authentication information input from predefined users;
a memory; and
a processor to:
execute an administrator password resetting mode in a case where the authentication information is input from t or more predefined users through the input device,
change an existing administrator password to a reset administrator password, and
store the reset administrator password in the memory,
wherein t is a natural number.

2. The image forming device as claimed in claim 1, wherein the input device sequentially receives the authentication information input from t of the predefined users.

3. The image forming device as claimed in claim 2, wherein the authentication information includes identification information of the predefined user, a password, or information stored in an authentication card.

4. The image forming device as claimed in claim 1, wherein the input device sequentially receives the authentication information input from portable memories in which the authentication information is stored.

5. The image forming device as claimed in claim 4, wherein the authentication information includes an identifier, a secret sharing universally unique identifier (UUID), a secret point, or a signature of the image forming device.

6. The image forming device as claimed in claim 5, wherein the processor identifies whether the secret points input from the t predefined users coincide with preset secret points of the image forming device on the basis of a number of input secret points and polynomial interpolation in a case where the secret points are input from the t predefined users.

7. The image forming device as claimed in claim 6, wherein the processor executes the administrator password resetting mode in a case where the secret points input from the t predefined users coincide with the preset secret points of the image forming device.

8. A control method of an image forming device, the control method comprising:
receiving authentication information input from predefined users;
executing an administrator password resetting mode in a case where the authentication information is input from t or more of the predefined users;
changing an existing administrator password to a reset administrator password; and
storing the reset administrator password,
wherein t is a natural number.

9. The control method as claimed in claim 8, wherein the receiving of the authentication information comprises sequentially receiving the authentication information from t of the predefined users.

10. The control method as claimed in claim 9, wherein the authentication information includes identification information of the predefined user, a password, or information stored in an authentication card.

11. The control method as claimed in claim 8, wherein the receiving of the authentication information comprise sequentially receiving the authentication information from t of the predefined users according to a request signal for administrator password resetting through a cloud.

12. The control method as claimed in claim 8, wherein the receiving of the authentication information comprises sequentially receiving the authentication information from portable memories in which the authentication information is stored.

13. The control method as claimed in claim 12, wherein the authentication information includes an identifier, a secret sharing UUID, a secret point, or a signature of the image forming device.

14. The control method as claimed in claim 13, further comprising identifying whether the secret points input from the t predefined users coincide with preset secret points of the image forming device on the basis of a number of input secret points and polynomial interpolation in a case where the secret points are input from the t predefined users,
wherein the administrator password resetting mode is executed in a case where the secret points input from the t predefined users coincide with the preset secret points of the image forming device.

15. A non-transitory computer readable recording medium in which a program for performing a control method of an image forming device is recorded, the control method of an image forming device including:
receiving authentication information input from predefined users;
executing an administrator password resetting mode in a case where the authentication information is input from t or more of the predefined users;
changing an existing administrator password to a reset administrator password; and
storing the reset administrator password,
wherein t is a natural number.
